(19) United States
(12) Patent Application Publication
(10) Pub. No.: US 2005/0046171 A1
(43) Pub. Date: Mar. 3, 2005

(54) Article of stationary

(76) Inventor: Ricardo Oscheneek, Boca Raton, FL (US)

Correspondence Address: Ricardo Oscheneek, 21320 Pagosa Ct., Boca Raton, FL, 33486, US

(21) Appl. No.: 10/651,173

(22) Filed: Aug. 28, 2003

(51) Int. Cl. B42D 1/00

(52) U.S. Cl. 281/15.1

(57) ABSTRACT

An article of stationary built by folding one sheet of paper approximately in the middle and closing it with a bonding system. The written part will be in the inside of the folded sheet. The article of stationary is preferably fabricated from paper but could also be fabricated with other materials such as plastic. The dimensions and shape of the article of stationary are not limited but it would be advisable to design it according to the Post Office recommendations for minimizing postage and maximizing processing speed. The article of stationary is an invention that assures both communicating parties the integrity of the printed information and the data by ensuring they always travel together, will not be separated and will not be incorrectly addressed.

### BACKGROUD OF THE INVENTION

1. Technical Field

The present invention relates to an article of stationary for concealing, keeping together and mailing printed information during the two-way process of sending and receiving back this article of stationary.

2. Background Art

The common practice to send a document containing confidential information is to insert it in a low transparency envelope, close it and mail it to the receiver address.

While having desirable qualities, common paper envelopes have some disadvantages. They tend to be bulky and heavy when dealing with large quantities. Also the amount of pollutants dumped into the environment resulting from the paper manufacturing process to produce envelopes, transport of the trees and final product have been drastically impacting the environment. Even though paper-manufacturing costs are low, the devastation of our forests is contributing day after day to an increasing unbalance of our environment.

The glue industry has created a number of sealing techniques basically developing a great variety of glues that guarantee a reliable closure. The paper industry has introduced the use of recycled paper as an alternative to lower the cellulose consumption, or in other words the cutting of the trees. Nevertheless recycled paper envelopes continue to be a big headache to Post Office high-speed reading machines because chemical residues present in the recycled paper considerably affect their reading capabilities.

Another significant disadvantage and probably the main one of using conventional paper envelopes is that they prompt their users to make countless mistakes because the information they carry is not together all the time. Courtesy envelopes were designed to alleviate this situation but they still did not solve the problem neither for the mailers, recipients or the Post Office.

The core of the problem resides in the fact that common envelopes do not establish a permanent tie between senders, receivers, documents or the information inside them. For example, it is easy to happen that a consumer mails a check to a company, which was initially intended for payment of another company's bill.

Best scenario, courtesy envelops and/or its contents are printed by one party in separated paper sheets in one end and completed by hand by the other party thus originating mistaken and/or incomplete documents.

### SUMARY OF THE INVENTION

The present invention solves the foregoing problems by providing an article of stationary formed with one sheet of paper that conceals predetermined preprinted information keeping the sender/receiver addresses and the correspondence content tied together during the sending, receiving, acknowledging and mailing cycle of a two-way mail piece.

As an example, the article of stationary can be formed with a stub detached from a regular commercial statement. The detached sheet is then folded one time approximately in the middle. One half becomes a cover, concealing the printed information on the other half, or this entire side of the sheet could be printed with any kind of information to be concealed. The four contiguous edges to the folded edge and the two opposite edges to the folded edge are closed together by means of a bonding system. To facilitate forming the article of stationary a crease should be created pre-folding the sheet after the printing stage. The article of stationary contains the pre-printed billing information, sender/receiver address, money withdrawal authorization or any other information to be concealed and mailed. This system allows the sender to mistake-proof mail his/her correspondence back to the right receiver, because sender, receiver and correspondence content are always together during the whole cycle.

In case the closed article of stationary has to be manually opened by the final receiver a line of perforation shall be created alongside the inner part of the bonding system. Perforated lines are not necessary if an industrial process as mechanical knifes, or die cuts is available for the opening.

This invention is preferably made out of paper but does not depend exclusively on this material or in any specific shape or format. Nevertheless Post Office dimensional and weight recommendations should be taken into consideration during the design stage of a specific article of stationary in a way to benefit from the speed of the Post Office sorting machines.

### SYSTEM ADVANTAGES

Preprinting the billing and addresses information and the money withdrawal authorization on predetermined positions of the article of stationary, will benefit all the parties as the:

Company Sending the Bill
1—Payments are received earlier because they can be electronically withdrawn from the bank using the printed authorization signed by the customer
2—Payments are received faster with the help of a properly designed article of stationary because the Post Office will process it in the Fast Track of their Optical Reading Machines.
3—Never receives a check that belongs to another company
4—Never receives a check filled with the wrong amount
5—Never miss a check because mailing address was unreadable by the Post Office
6—Company Optical Reading Equipment reads this article of stationary faster because some of the information can be read trough predetermined window cuts in the cover.
7—Company Optical Reading Equipment reads this article of stationary faster because there is no loose sheets inside the article of stationary to make coincide with the windows
8—Company Optical Reading Equipment reads more accurately because the information printed in this article of stationary is printed by the company quality printers
9—This article of stationary costs much less than common courtesy envelopes

Customer Paying the Bill
1—Never sends a payment to the wrong company. The company address is properly preprinted in this courtesy article of stationary by the company
2—Never fills a check with the wrong or misspelled amount. The amount due is properly preprinted by the company in the authorization for withdrawal
3—Never sends a check with his wrong or misspelled address. His address is properly preprinted on the article of stationary by the company
4—Never sends a check with a wrong sender address. His/her address is properly preprinted by the company on the article of stationary
5—Never sends mail that will not be identified by the Post Office. Articles of stationary are designed and made according to the Post Office recommendations.
6—Do not have to fill a check. Customer can assign a bank account to be withdrawn and debit can be authorized in a case-by-case basis.
7—Do not have to lick the article of stationary. A bonding system can be used to avoid such inconvenience.
8—It is safer. There is no need to mail any checks.
9—It is easier to control because withdrawal authorization is given in a case-by-case basis.
10—It is faster. There is no need to copy the same information over and over again. All necessary information is already printed in the article of stationary. Customer has just to sign and date the preprinted document, close and mail it back.

The Post Office Processing the Mail
1—Will reduce the actual 30% Fast-Track reading rejection rate due to misspelled addresses, bad handprints, wrongly inserted address cards or address information aside from the envelope windows
2—Transports less weight, because bank checks are not needed and the article of stationary weight much less than envelopes, checks and stubs together
3—Transports less volume because article of stationary are smaller and thinner than envelopes, checks and stubs all together
4—Mail is delivered faster because article of stationary is properly designed to be sorted by the Fast-Track Optical Reading machines
5—Postman delivers the mail easier because addresses are clearly printed in the right size and placed

The Environment
1—Millions of trees are saved per year
2—Hundreds of thousands of acres are freed for cultivating food
3—Saves millions of gallons of fuel spent with the trees and mail transportation
4—Is protected against the dumping of millions of pounds of different pollutants part of the paper manufacturing process

The example herein was just used to show the advantages in one of many different uses this article of stationary can have.

As a whole this article of stationary produces very utilitarian results functioning in a unique manner.

### BRIEF DESCRIPTION OF THE DRAWINGS

FIG. 1 is a front view of a sheet comprising an account statement, a stub and cover.

FIG. 2 shows a detached stub/cover from its statement

FIG. 3 is a cross section of a closed article of stationary showing the folded sheet, the bonding system and the indicia location

FIG. 4 is the front view of a closed article of stationary showing the sender and receiver addresses, the receiver mailing barcode and the indicia position

FIG. 5 is the back of a closed article of stationary

FIG. 6 is the front view of article of stationary with an alternative perforated opening system

FIG. 7 is the back view of FIG. 6 article of stationary with an alternative perforated opening system

FIG. 8 is an alternative article of stationary showing a front window for the display of the sender and receiver addresses as well as a window for sender's signature and authorization to the primary document sender to use a previously authorized bank account

FIG. 9 is the back of FIG. 8 of the alternative article of stationary

FIG. 10 is an alternative for a check-article of stationary using the same principles of forming, opening and closing described herein. The illustration shows the front view of a check and cover.

FIG. 11 is an alternative for a letter-article of stationary using the same principles of forming, opening and closing described herein. The illustration shows the front view of a letter article of stationary

### DESCRIPTION OF THE PREFFERED ARTICLE OF STATIONARY

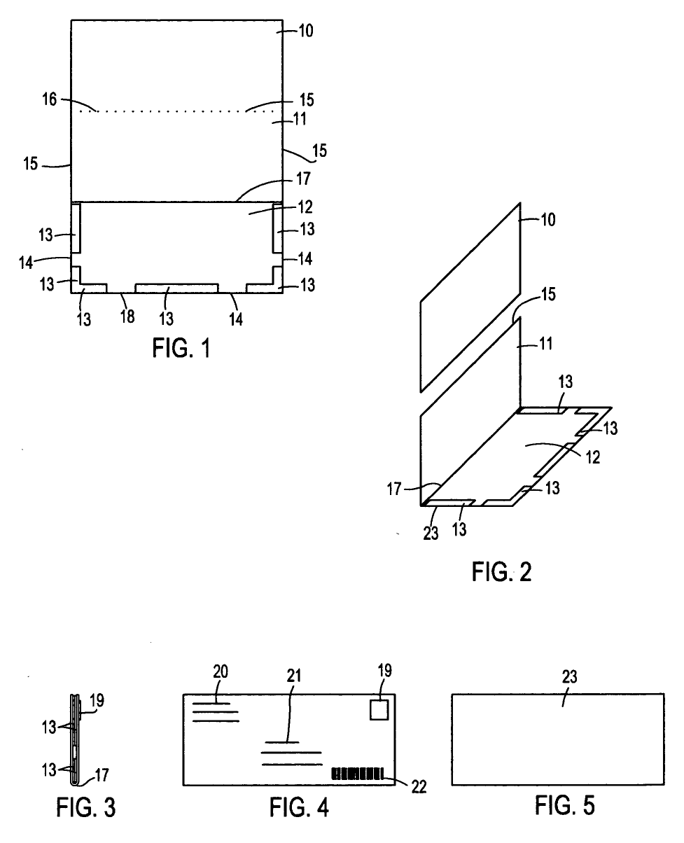

Referring to FIG. 1, this figure shows a front view of a preferred format for a sheet comprising of a statement (10)/stub (11)/article of stationary cover (12). The cover edges (14) carry a bonding system (13) placed adjacent to the two contiguous edges (14) to the folded edge (17) and the opposite edge (18) of the folded edge of the stub (17). All three edges of the cover have a bonding system, for instance a self-seal glue pad with peel-off protection stripes (13). To make it easier the cover edges (14) to coincide with stub edges (15) when flipping the cover (12) over the stub portions (11) of the article of stationary to-be-formed, the folded edge (17) should be pre-folded after the printing process of the statement/stub/cover article of stationary sheet. A perforated line (16) is punched alongside the common edge of the statement (10) and the stub (11) to facilitate cutting off the statement portion (10) from the stub/cover (11)/(12) when done by hand.

FIG. 2 is a view of the stub (11)/cover sheet (12) detached from the statement (10). To form and close the article of stationary the bonding system (13) has to be activated and one portion of the sheet flipped over the other covering the predetermined information contained in the stub (11). The stub (11) is printed with all necessary information, as for instance from where the money is going to be drawn, account numbers, amount to be drawn, a place for the signature of the payee and, the date of his/her signature, address change option and eventually a bar code detailing most of these information.

In FIG. 3 is a cross section of the article of stationary where we can see the folded stub (11)/cover sheet (12), the bonding system (13) and the place for the indicia (19).

FIG. 4 is a front view of the formed article of stationary where we can see the sender (20) and receiver (21) preprinted addresses, the indicia (19) and the receiver zip code bar code (22).

FIG. 5 is the back view of the formed article of stationary where we just see the stub (11) blank back (23).

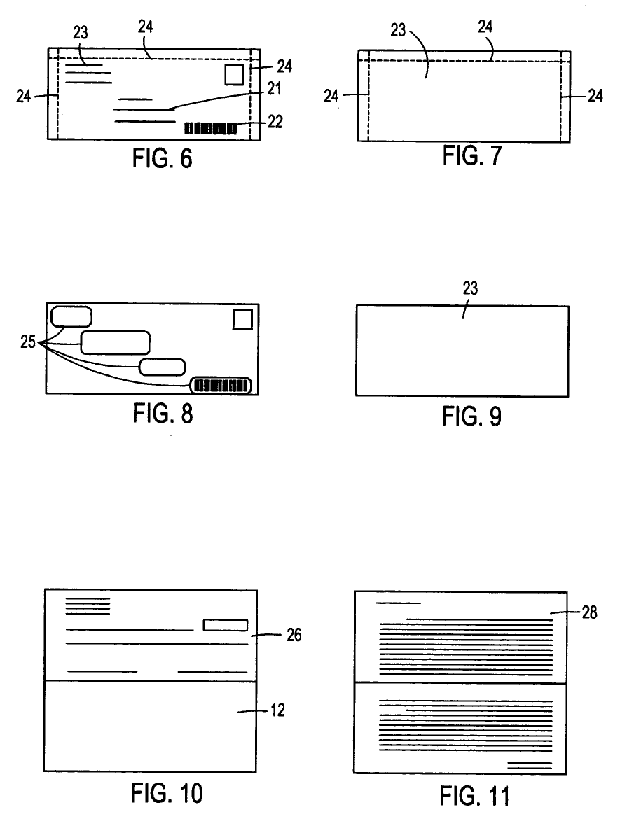

FIG. 6 is the front view of an already formed article of stationary where we can see the perforated line (24) used when the receiver has no mechanical equipment to open the article of stationary. It can be seen also the place for the indicia (19), the sender (20) and receiver addresses (21) and the receiver barcode zip code (22).

FIG. 7 is the back view of the formed article of stationary where we see the stub (11) blank back (23) and the perforated lines (24).

FIG. 8 is the front view of a formed alternative article of stationary used by companies that don't have dual sided printers. A convenient number of windows (25) are opened in the cover (12) in a way selected information on the stub can be read from the outside through these windows (25). The indicia can be seen in the proper position. Depending on the receiver's method of opening the article of stationary a perforated line can also be punched alongside the proper edges.

FIG. 9 is the back view of the formed article of stationary where we just see the stub (11) blank back (23) and the perforated lines (24).

FIG. 10 is an alternative for a check-article of stationary using the same principles of forming, closing and opening the article of stationary described herein. The illustration shows the front view of a check (26) and the cover (12).

FIG. 11 is an alternative for a letter-article of stationary using the same principles of forming, closing and opening described herein. The illustration shows the front view of a letter (28) written on an article of stationary.

1. An article of stationary for keeping together in one sheet of paper all the necessary sender and receiver information during the whole process of sending, receiving and opening a correspondence comprising the steps of:
a- printing all the necessary sender and receiver information in predetermined places on a single sheet of paper
b- folding the single sheet of paper in a way to conceal predetermined printed information making coincide its loose edges
c- closing the formed article of stationary by activating a bond system placed alongside the said edges
